(19) United States
(12) Patent Application Publication
(10) Pub. No.: US 2015/0092844 A1
(43) Pub. Date: Apr. 2, 2015

(54) INTRA-PREDICTION METHOD FOR MULTI-LAYER IMAGES AND APPARATUS USING SAME

(71) Applicant: ELECTRONICS AND TELECOMMUNICATIONS RESEARCH INSTITUTE, Daejeon (KR)

(72) Inventors: Ha Hyun Lee, Seoul (KR); Jung Won Kang, Daejeon (KR); Jin Soo Choi, Daejeon (KR); Jin Woong Kim, Daejeon (KR)

(73) Assignee: ELECTRONICS AND TELECOMMUNICATIONS RESEARCH INSTITUTE, Daejeon (KR)

(21) Appl. No.: 14/385,633

(22) PCT Filed: Mar. 18, 2013
(86) PCT No.: PCT/KR2013/002201

§ 371 Date: Sep. 16, 2014

(30) Foreign Application Priority Data
Mar. 16, 2012 (KR) 10-2012-0026986
Mar. 18, 2013 (KR) 10-2013-0028841

(51) Int. Cl. H04N 19/593; H04N 19/176

(52) U.S. Cl. CPC H04N 19/593; H04N 19/176
USPC 375/240.12

(57) ABSTRACT

An intra-prediction method for multi-layer images is provided. The method comprises the steps of: deriving an intraprediction mode of a predictive target block of an enhanced layer; generating an alternative sample for an unavailable reference sample of the predictive target block on the basis of a reference layer for the enhanced layer; and generating a predictive block for the predictive target block by using the intra-prediction mode and the alternative sample.

### TECHNICAL FIELD

The present invention relates to video processing and, more particularly, to an intra prediction method for a multi-layer video and an apparatus using the same.

### BACKGROUND ART

As a broadcasting system supporting High Definition (HD) resolution spreads recently worldwide as well as locally, many users become accustomed to videos having high resolution and high definition. Accordingly, lots of groups are putting spurs to the development of the next-generation video device.

As the resolution and definition of a video become higher, the amount of information about the video increase. Devices having a variety of performances and networks having a variety of environments appear due to the increase in the amount of information about a video. Accordingly, the same content can become available with a variety of qualities. That is, as the quality of a video supported by a video device and a network used (by a video device) are diversified, a video having common quality can used in some environment, but a video having high quality can be used in other environments.

Accordingly, it is necessary to provide scalability to the quality of a video in order to provide the quality of a video required by a user in various environments.

### DISCLOSURE

### Technical Problem

An object of the present invention is to provide an intra prediction method for a multi-layer video and an apparatus using the same.

### Technical Solution

In an aspect, an intra prediction method for a multi-layer video is provided. The method comprises steps of: deriving an intra prediction mode of a prediction target block of an enhancement layer, generating a replacement sample corresponding to an unavailable reference sample of the prediction target block based on a reference layer corresponding to the enhancement layer, and generating a prediction block corresponding to the prediction target block using the intra prediction mode and the replacement sample and available reference sample of the prediction target block.

In another aspect, an intra prediction method for a multi-layer video is provided. The method comprises steps of deriving an intra prediction mode for a prediction target block of an enhancement layer, generating a replacement sample corresponding to an unavailable reference sample of the prediction target block, the replacement sample generated based on an available reference sample of the prediction target block or a reference layer corresponding to the enhancement layer, and generating a prediction block corresponding to the prediction target block using the intra prediction mode and the replacement sample and available reference sample of the prediction target block.

The reference layer may be obtained by up-sampling a base layer corresponding to the enhancement layer, based on a video size of the enhancement layer.

The replacement sample may be a sample of reference layer corresponding to the unavailable reference sample in the enhancement layer. The replacement sample may be a sample adjacent to a sample of reference layer corresponding to the unavailable reference sample in the enhancement layer.

The step of generating the replacement sample may include a step of checking whether or not reference samples of the prediction target block are available. Whether or not the reference samples are available may be determined based on whether or not the prediction target block is adjacent to a boundary of a picture, slice, or tile.

In yet another aspect, a video decoder is provided. The video decoder comprises a block prediction module for generating a prediction block of the prediction target block, and an adder for generating a reconstructed block by adding the prediction block to a residual block of the prediction target block received from a video encoder. The block prediction module is configuring for: deriving an intra prediction mode of a prediction target block of an enhancement layer, generating a replacement sample corresponding to an unavailable reference sample of the prediction target block based on a reference layer corresponding to the enhancement layer, and generating a prediction block corresponding to the prediction target block using the intra prediction mode and the replacement sample and available reference sample of prediction target block.

The reference layer may be obtained by up-sampling a base layer corresponding to the enhancement layer, based on a video size of the enhancement layer.

The replacement sample may be a sample of reference layer corresponding to the unavailable reference sample in the enhancement layer. The replacement sample may be a sample adjacent to a sample of reference layer corresponding to the unavailable reference sample in the enhancement layer.

The block prediction module may check whether or not reference samples of the prediction target block are available. Whether or not the reference samples are available may be determined based on whether or not the prediction target block is adjacent to a boundary of a picture, slice, or tile.

### Advantageous Effects

The coding efficiency of intra prediction is improved.

### BRIEF DESCRIPTION OF THE DRAWINGS

FIG. 1 is a block diagram showing an example of the structure of a video encoder.

FIG. 2 is a block diagram showing an example of the structure of a video decoder.

FIG. 3 shows an example in which one unit is partitioned into a plurality of lower units.

FIG. 4 is a flowchart illustrating an example in which intra prediction is performed.

FIG. 5 shows 33 neighboring reference samples when the size of a prediction target block is 8×8.

FIG. 6 shows an example in which neighboring reference samples are replaced.

FIG. 7 is a flowchart illustrating an intra prediction method for a multi-layer video in accordance with an embodiment of the present invention.

FIGS. 8 to 10 show the replacement of reference samples in a current layer based on a reference layer in accordance with an embodiment of the present invention.

FIGS. 11 to 13 show the replacement of reference samples in a current layer based on a reference layer in accordance with another embodiment of the present invention.

FIGS. 14 to 16 show the replacement of reference samples in a current layer based on a reference layer in accordance with yet another embodiment of the present invention.

FIG. 17 is a flowchart illustrating an intra prediction method for a multi-layer video in accordance with another embodiment of the present invention.

### MODE FOR INVENTION

Hereinafter, embodiments of the present invention are described in detail with reference to the accompanying drawings. In describing the present invention, a detailed description of a known art related to the present invention will be omitted if it is deemed to make the gist of the present invention unnecessarily vague.

When it is said that one element is “connected”, “combined”, or “coupled” with the other element, the one element may be directly connected or coupled with the other element, but it should also be understood that a third element may be “connected”, “combined”, or “coupled” between the two elements. Furthermore, in the present invention, when it is described that a specific element is “included”, it means that elements other than the specific element are excluded, but that additional elements may be included in the embodiment of the present invention or the scope of the technical spirit of the present invention.

Terms, such as “the first” and “the second”, may be used to describe various elements, but the elements should not be restricted by the terms. That is, the terms are used to only distinguish one element and the other element from each other. Accordingly, a first element may be named a second element. Likewise, a second element may be named a first element.

Furthermore, elements described in the embodiments of the present invention are independently shown in order to indicate that the elements perform different and characteristic functions, and it does not mean that each element may not be implemented a piece of hardware or software. That is, each element is classified for convenience of description, and a plurality of elements may be combined to operate as one element or one element may be divided into a plurality of elements and the plurality of elements may operate. This is included in the scope of the present invention unless it does not depart from the essence of the present invention.

Furthermore, some elements may be optional elements for improving performance not essential elements for performing their essential functions. The present invention may be implemented using only essential elements other than optional elements, and a structure including only the essential elements are also included in the scope of the present invention.

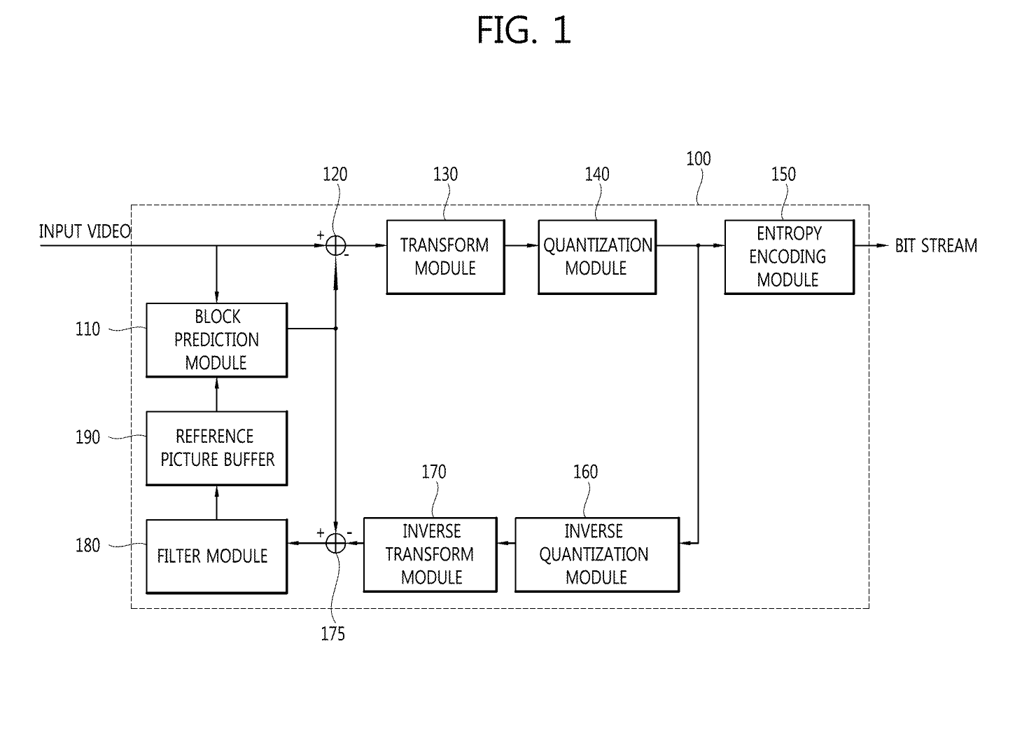

FIG. 1 is a block diagram showing an example of the structure of a video encoder.

The video encoder 100 includes a block prediction module 110, a subtractor 120, a transform module 130, a quantization module 140, an entropy encoding module 150, an inverse quantization module 160, an inverse transform module 170, an adder 175, a filter module filter module 180, and a reference picture buffer 190.

The video encoder 100 outputs a bitstream by performing intra prediction, inter-prediction, entropy encoding, etc. on an input video. Intra prediction means that a pixel value is predicted using pixel information within a picture, and inter-prediction means that a pixel value included in a current picture is predicted from a precedent picture and/or a following picture. Entropy encoding technology means that a short sign is assigned to a symbol having a high frequency of occurrence and a long sign is assigned to a symbol having a low frequency of occurrence.

In order to compress the input video, the video encoder 100 generates a prediction block for the input block of the input video and encodes a residual between the input block and the prediction block. In intra prediction, the block prediction module 110 generates the prediction block by performing spatial prediction using a pixel value of an already encoded block neighboring an encoding target block. In inter-prediction, the block prediction module 110 searches for a reference block, most well matched with the input block, within reference pictures stored in the reference picture buffer 190, obtains a motion vector using the retrieved reference block, and generates the prediction block by performing motion compensation using the motion vector. Here, the motion vector is a two-dimensional vector used in inter-prediction, and the motion vector indicates an offset between an encoding/decoding target block and the reference block.

The subtractor 120 generates a residual block based on the residual between the input block and the prediction block, and the transform module 130 outputs a transform coefficient by transforming the residual block. The quantization module 140 outputs a quantized coefficient by quantizing the transform coefficient.

The entropy encoding module 150 outputs a bit stream by performing entropy encoding based on information obtained in the encoding/quantization processes. In entropy encoding, the size of a bitstream for a target symbol to be encoded is reduced by representing a frequently occurring symbol using a small number of bits. Entropy encoding improves the compression performance of a video. The entropy encoding module 150 can use an encoding method, such as exponential Golomb or Context-Adaptive Binary Arithmetic Coding (CABAC), for the entropy encoding.

Meanwhile, an encoded picture needs to be decoded and stored in order to be used as a reference picture for performing inter-prediction.

Accordingly, the inverse quantization module 160 inversely quantizes the quantized coefficient, and the inverse transform module 170 outputs a reconstructed residual block by inversely transforming the inversely quantized coefficient. The adder 175 generates a reconstructed block by adding the reconstructed residual block to the prediction block.

The filter module 180 is also called an adaptive in-loop filter, and the filter module 180 performs one or more of deblocking filtering, Sample Adaptive Offset (SAO) compensation, and Adaptive Loop Filtering (ALF) to the reconstructed block. Deblocking filtering means that the distortion of a block occurring at the boundary of blocks is removed, and SAO compensation means that an appropriate offset is added to a pixel value in order to correct a coding error. Furthermore, ALF means that filtering is performed based on a comparison value between a reconstructed video and the original video.

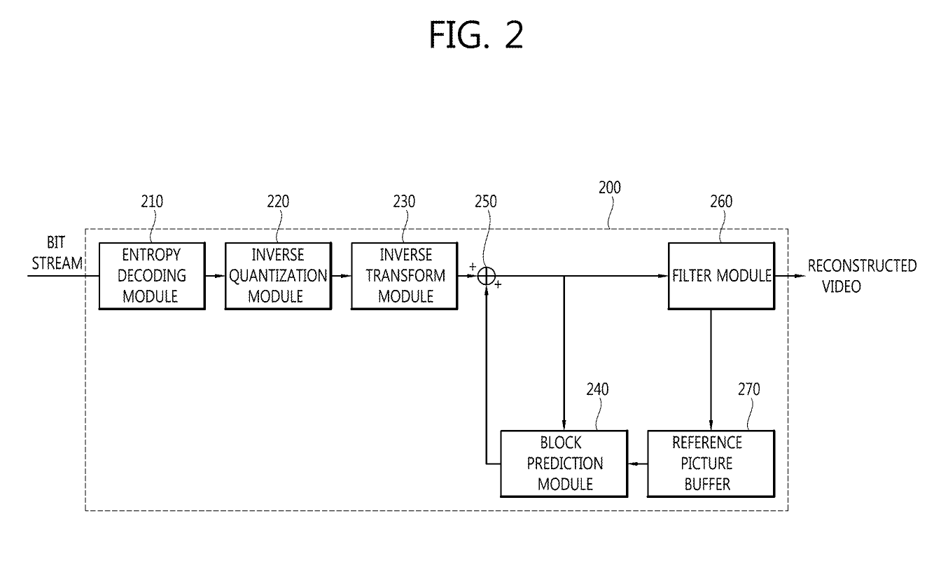

FIG. 2 is a block diagram showing an example of the structure of a video decoder.

The video decoder 200 includes an entropy decoding module 210, an inverse quantization module 220, an inverse transform module 230, a block prediction module 240, an adder 250, a filter module 260, and a reference picture buffer 270.

The video decoder 200 restores a reconstructed video from a bitstream by performing intra prediction, inter-prediction, entropy decoding, etc. That is, the video decoder 200 obtains a residual block from the bitstream, generates a prediction block for the reconstructed block, and generates a reconstructed block by adding the residual block and the prediction block.

The entropy decoding module 210 performs entropy decoding based on a probability distribution. The entropy decoding process is a process opposite to the above-described entropy encoding process. That is, the entropy decoding module 210 generates a symbol including a quantized coefficient from the bitstream in which a frequently occurring symbol is represented by a small number of bits.

The inverse quantization module 220 inversely quantizes a quantized coefficient, and the inverse transform module 230 generates the residual block by inversely transforming the inversely quantized coefficient.

In intra prediction, the block prediction module 240 generates the prediction block by performing spatial prediction using a pixel value of an already decoded block neighboring a decoding target block. In inter-prediction, the block prediction module 240 generates the prediction block by performing motion compensation using a motion vector and a reference picture stored in the reference picture buffer 270.

The adder 250 adds the prediction block to the residual block, and the filter module 260 outputs a reconstructed video by performing one or more of deblocking filtering, SAO compensation, and ALF on a block that has passed through the adder.

Hereinafter, a unit means a unit for video encoding and decoding. In encoding/decoding processes, a video is partitioned into specific sizes and encoded/decoded. Accordingly, a unit can be classified into and called a Coding Unit (CU), a Prediction Unit (PU), a Transform Unit (TU), etc. depending on its encoding/decoding processes. Furthermore, a unit may also be called a block. One unit can be further partitioned into smaller lower units.

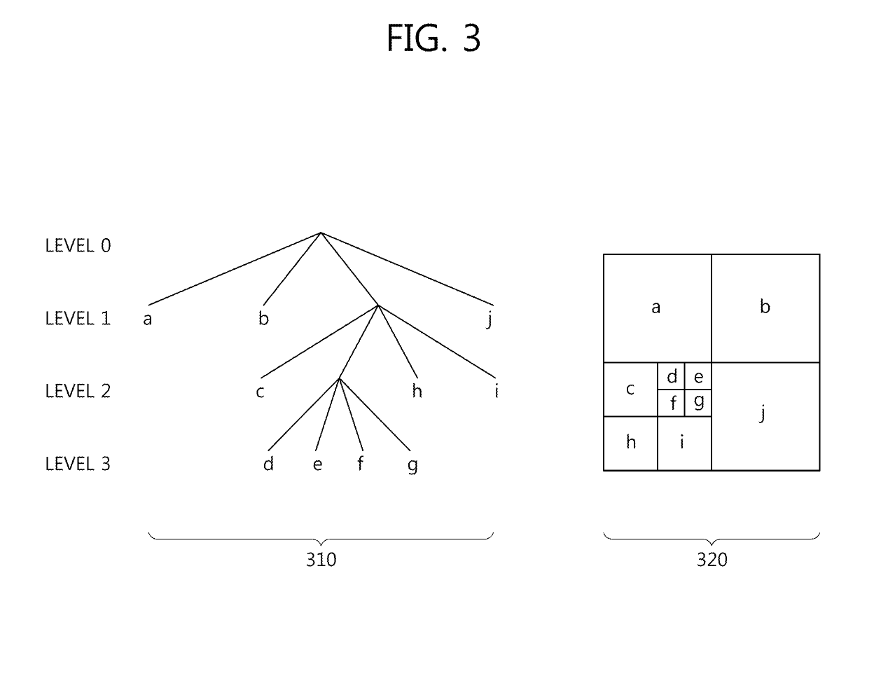

FIG. 3 shows an example in which one unit is partitioned into a plurality of lower units.

One unit can be partitioned in a layer way with depth information based on a tree structure. Each of partitioned lower units can have depth information. The depth information may include information about the size of a lower unit because the depth information indicates the number and/or degree of partitions.

Referring to 310 of FIG. 3, the highest node may be called a root node, and it can have the smallest depth value. Here, the highest node can have the depth of a level 0 and can represent the first unit that has not been partitioned.

A lower node having the depth of a level 1 can indicate a unit partitioned from the first unit once. A lower node having the depth of a level 2 can indicate a unit partitioned from the first unit twice. For example, in 320 of FIG. 3, a unit a corresponding to a node a is a unit partitioned from the first unit once, and it can have the depth of the level 1.

A leaf node having a level 3 can indicate a unit partitioned from the first unit three times. For example, in 320 of FIG. 3, a unit d corresponding to a node d is a unit partitioned from the first unit three times, and it can have the depth of the level 3. Accordingly, the leaf node having the level 3, that is, the lowest node, can have the deepest depth.

Hereinafter, a target encoding/decoding block may also be called a current block if necessary. Furthermore, if intra prediction is performed on a encoding/decoding target block, the encoding/decoding target block may also be called a prediction target block.

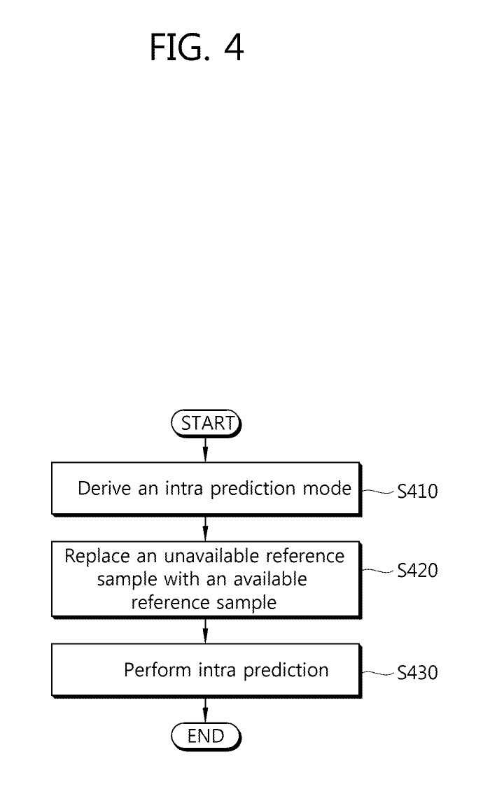

FIG. 4 is a flowchart illustrating an example in which intra prediction is performed.

In intra prediction, the block prediction module derives an intra prediction mode for a prediction target block (S410). Intra prediction can be divided into non-angular prediction and angular prediction. High Efficiency Video Coding (HEVC), that is, a new video compression standard on which JCT-VC, that is, an international video compression standardization group, performs a standardization task provides non-angular prediction modes, including Intra_Planar mode and Intra_DC mode, and 33 angular prediction modes including horizontal prediction and vertical prediction.

In intra prediction, spatial prediction using a sample value neighboring a prediction target block is performed. A sample neighboring a prediction target block and used for prediction may also be called a reference sample, and the number of neighboring samples nSample necessary for intra prediction is determined based on the size nS of a prediction target block below.

nSample=nS*4+1 Equation 1

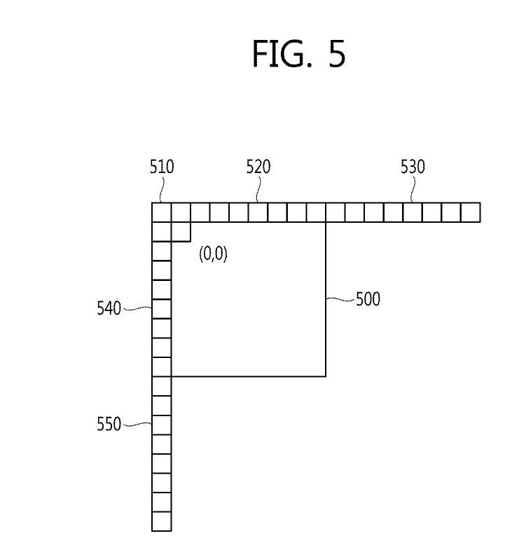

For example, if the size of a prediction target block is 8×8, 33 neighboring reference sample values are necessary to perform intra prediction. FIG. 5 shows 33 neighboring reference samples when the size of a prediction target block is 8×8. An example in which the size of a prediction target block is 8×8 is described below, for convenience of description. Furthermore, it is assumed that coordinates x-y increase right-downward on the basis of the top-left sample of the prediction target block. For example, the coordinates of the top-left sample of the prediction target block 500 can be represented by (0,0), the coordinates of a left-above reference sample 510 of the prediction target block 500 can be represented by (−1,−1), the coordinates of an above reference sample 520 of the prediction target block 500 can be represented by (0 . . . 7,−1), and the coordinates of a right-above reference sample 530 of the prediction target block 500 can be represented by (8 . . . 15,−1). Likewise, the coordinates of a left reference sample 540 of the prediction target block 500 can be represented by (−1,0 . . . 7), and the coordinates of a left-below reference sample 550 of the prediction target block 500 can be represented by (−1,8 . . . 15).

Meanwhile, in the case that neighbor of a prediction target block has not yet been (de)coded or the prediction target block is placed at a picture/slice/tile boundary, a neighboring reference sample may be unavailable. A process of replacing an unavailable reference sample can be performed.

Referring back to FIG. 4, the block prediction module replaces an unavailable reference sample, from among the neighboring reference samples of the prediction target block, with an available reference sample from among the neighboring reference samples of the prediction target block (S420). The process of replacing a reference sample may also be called a padding process. In accordance with Section 8.4.3.1.1 of “High efficiency video coding (HEVC) text specification draft 6” disclosed on November, 2011, if at least one reference sample is unavailable,

1. If a reference sample located at (−1,nS*2−1) is unavailable, available reference samples are sequentially searched for from (−1,nS*2−1) to (−1,−1) and then from (0,−1) to (nS*2−1,−1). If an available reference sample is detected, the search is terminated, and the sample value p[−1,nS*2−1] is assigned as a value of a detected sample.

2. If (−1,nS*2−2 . . . −1) is unavailable, the sample value p[x,y] is replaced with a value p[x,y+1] of a below sample.

3. If (nS*2−2 . . . −1,−1) is unavailable, the sample value p[x,y] is replaced with a value p[x−1,y] of a left sample.

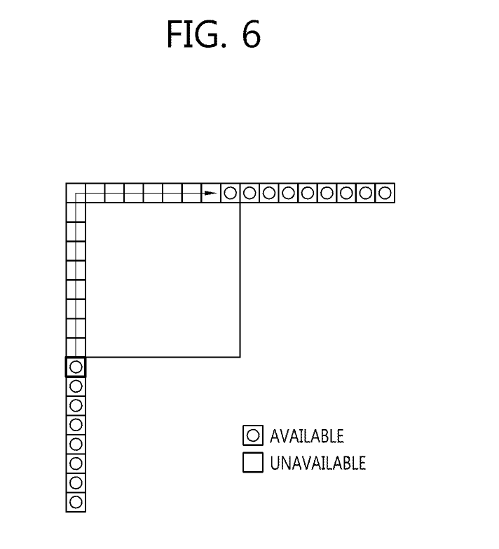

FIG. 6 shows an example in which neighboring reference samples are replaced.

Referring to FIG. 6, if samples from (−1,7) to (−1,−1) and samples from (0,−1) to (6,−1) are unavailable, values of the samples are replaced with a value of a sample located at (−1,8).

Referring back to FIG. 4, the block prediction module generates a prediction block by performing intra prediction on the prediction target block (S430). That is, the block prediction module performs intra prediction using neighboring reference samples based on the derived intra prediction mode.

For example, if a prediction target block has been encoded in a vertical prediction mode, a sample value of a prediction block is derived as a value of a sample having the same x coordinates, from among reference samples adjacent at a boundary above the prediction target block. That is, the value predSamples[x,y] of the sample of the prediction block is derived as in Equation 2.

predSamples[x,y]=p[x,−1], with x,y=0 . . . nS−1 Equation 2

Here, p[a,b] indicates a value of a sample having a location (a, b).

For example, if a prediction target block has been encoded in a horizontal prediction mode, a sample value of a prediction block is derived as a value of a sample having the same y coordinates, from among reference samples adjacent at a boundary on the left of the prediction target block. That is, the value predSamples[x,y] of the sample of the prediction block is derived as in Equation 3.

predSamples[x,y]=p[−1,y], with x,y=0 . . . nS−1 Equation 3

Meanwhile, in order to support a video having high resolution and high definition, devices having a variety of performances and networks having a variety of environments are appearing. Accordingly, the same content has become available with a variety of qualities. That is, as the quality of a video supported by a video device and a network used (by a video device) are diversified, a video having common quality can be used in some environment, but a video having high quality can be used in other environments. For example, a consumer who has purchased video content using a mobile device can watch the purchased video content using a display (e.g., digital TV) in the house with a wider screen and higher resolution. In order to provide services requested by users in various environments, scalability can be provided to the quality of a video.

In a video coding method supporting scalability (hereinafter referred to as ‘scalable coding’), input signals can be processed by the layer. At least one of a resolution, a frame rate, a bit-depth, a color format, and an aspect ratio may be different between input signals (input videos), depending on the layer.

Hereinafter, scalable coding includes scalable encoding and scalable decoding. In scalable coding, redundant transmission/processing of information are reduced and compression efficiency are improved by performing inter-layer prediction using a similarities between layers, that is, based on scalability.

As described above, in conventional intra prediction, an unavailable neighboring reference sample is replaced with another available neighboring reference sample. If unavailable reference samples are contiguous to each other, the characteristics of a prediction target block may not be sufficiently reflected by replaced reference samples. Accordingly, the present invention proposes an intra prediction method using the samples of a reference layer that have been already reconstructed in scalable coding based on a multi-layer structure. That is, the present invention proposes a method of performing intra prediction by replacing unavailable reference samples of a higher layer with corresponding samples of a reference layer. In accordance with the proposed method, the coding efficiency of intra prediction can be improved because the characteristics of a prediction target block are sufficiently reflected by a replaced reference sample.

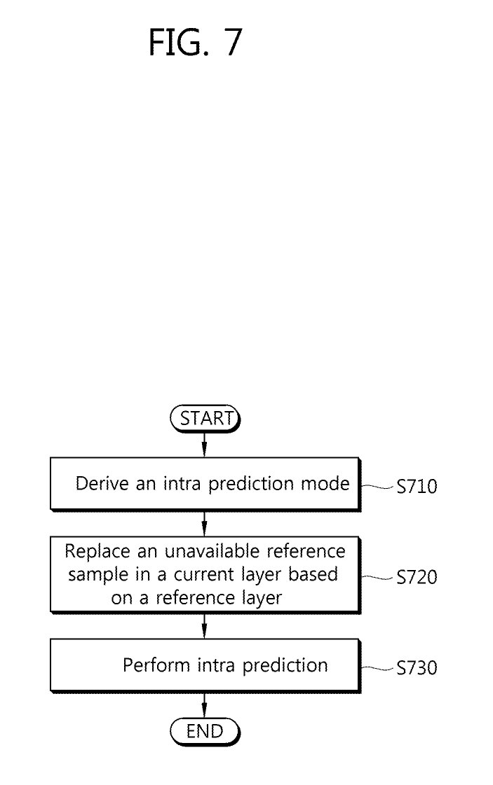

FIG. 7 is a flowchart illustrating an intra prediction method for a multi-layer video in accordance with an embodiment of the present invention.

The block prediction module derives an intra prediction mode for a prediction target block in a current layer (S710). In a multi-layer video system, a base layer that is basically provided and an enhancement layer that is additionally provided are provided. The base layer can be called a lower layer, a reference layer or the like, and the enhancement layer can be called a higher layer, a current layer or the like. In order to clearly describe scalable coding in the enhancement layer hereinafter, the base layer is called a reference layer and the enhancement layer is called a current layer.

The block prediction module replaces an unavailable reference sample, from among reference samples neighboring the prediction target block in the current layer, based on the reference layer (S720). That is, the block prediction module generates a replacement sample for the unavailable reference sample of the prediction target block based on the reference layer in the current layer.

Meanwhile, the current layer and the reference layer can have different input video sizes. In general, the input video size of a current layer, that is, an enhancement layer, is greater than the input video size of a reference layer, that is, a basic layer. Thus, the video of the reference layer has to be up-sampled based on a ratio of the reference layer and the current layer and used. Accordingly, the process of replacing the reference sample based on a sample value of the reference layer (S720) can include a process of up-sampling the video of the reference layer. The up-sampling process is performed in a picture unit, but may be performed in a smaller unit (e.g., a Largest Coding Unit (LCU) or a block). It is hereinafter assumed that the current layer and the reference layer are made to have the same input video size through the up-sampling process, etc. for the video of the reference layer.

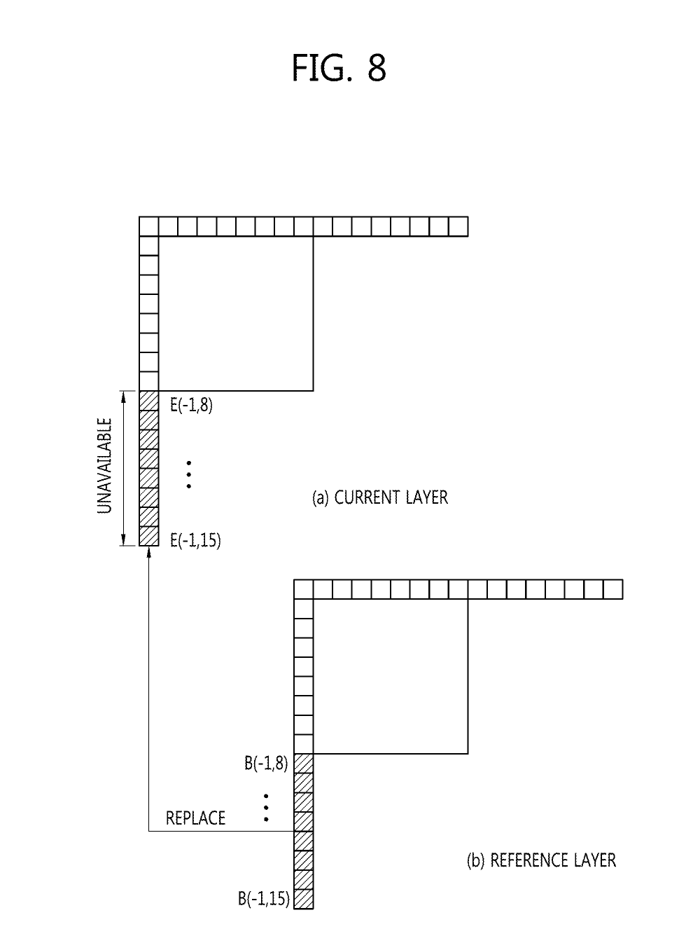

FIGS. 8 to 10 show the replacement of reference samples in a current layer based on a reference layer in accordance with an embodiment of the present invention.

Referring to FIG. 8, left-below reference samples of a prediction target block in a current layer are unavailable. The block prediction module can replace the left-below reference samples of the prediction target block in the current layer with left-below reference samples of a block corresponding to the prediction target block in a reference layer. That is, if reference samples located from (−1,8) to (−1,15) in the current layer are unavailable, values of the corresponding reference samples can be replaced with values of reference samples located from (−1,8) to (−1,15) in an up-sampled reference layer.

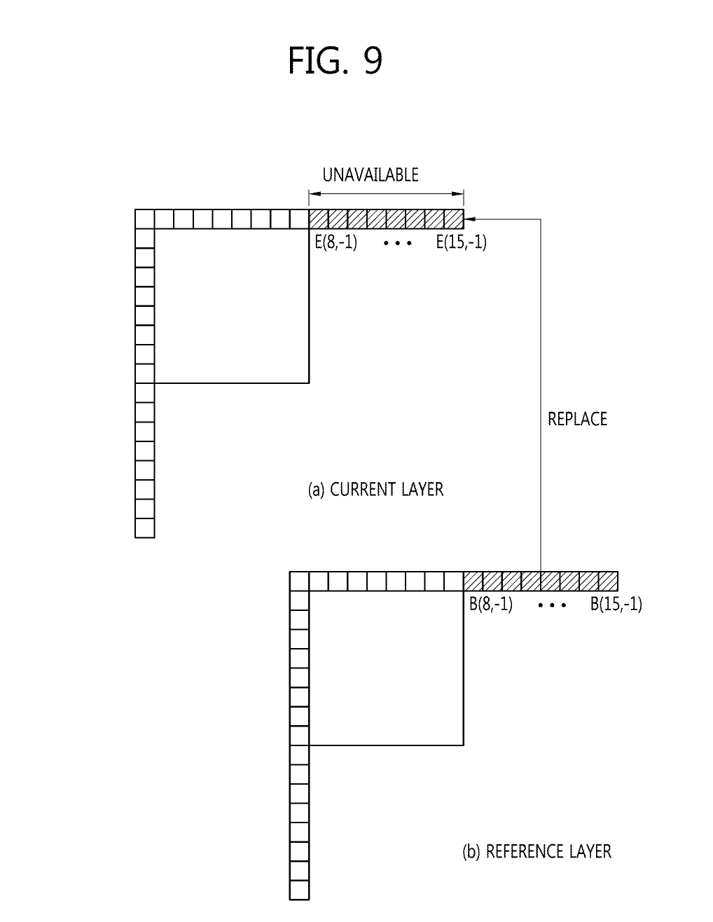

Referring to FIG. 9 right-above reference samples of a prediction target block in a current layer are unavailable. The block prediction module can replace the right-above reference samples of the prediction target block in the current layer with right-above reference samples of a block corresponding to the prediction target block in a reference layer. That is, if reference samples located from (8,−1) to (15,−1) in the current layer are unavailable, values of the corresponding reference samples can be replaced with values of reference samples located from (8,−1) to (15,−1) in an up-sampled reference layer.

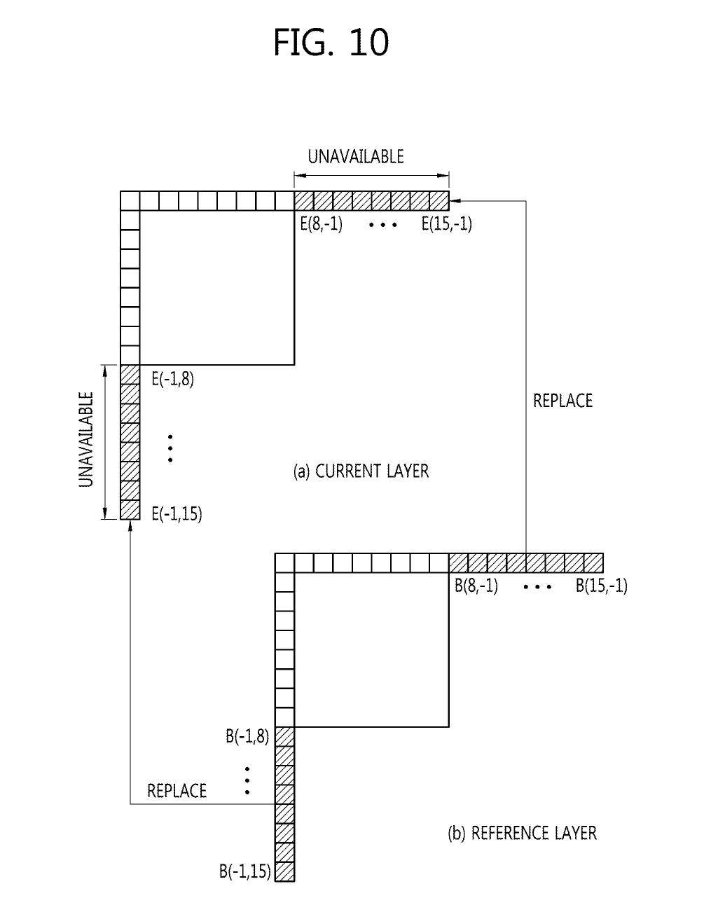

Referring to FIG. 10, left-below reference samples and right-above reference samples of a prediction target block in a current layer are unavailable. The block prediction module can replace the left-below reference samples and the right-above reference samples of the prediction target block in the current layer with left-below reference samples and right-above reference samples of a block corresponding to the prediction target block in a reference layer. That is, if reference samples located from (−1,8) to (−1,15) and reference samples located from (8,−1) to (15,−1) in the current layer are unavailable, values of the corresponding reference samples can be replaced with values of reference samples located from (−1,8) to (−1,15) and reference samples located from (8,−1) to (15,−1) in an up-sampled reference layer.

Meanwhile, in the examples of FIGS. 8 to 10, all the left-below reference samples and/or the right-above reference samples of the prediction target block in the current layer may not be unavailable, but some of them may be unavailable. If some reference samples are unavailable, the unavailable reference samples are replaced with corresponding reference samples in a reference layer. For example, if a reference sample located at (−1,10) in the current layer is unavailable, a value of the corresponding reference sample can be replaced with a value of a reference sample located at (−1,10) in an up-sampled reference layer.

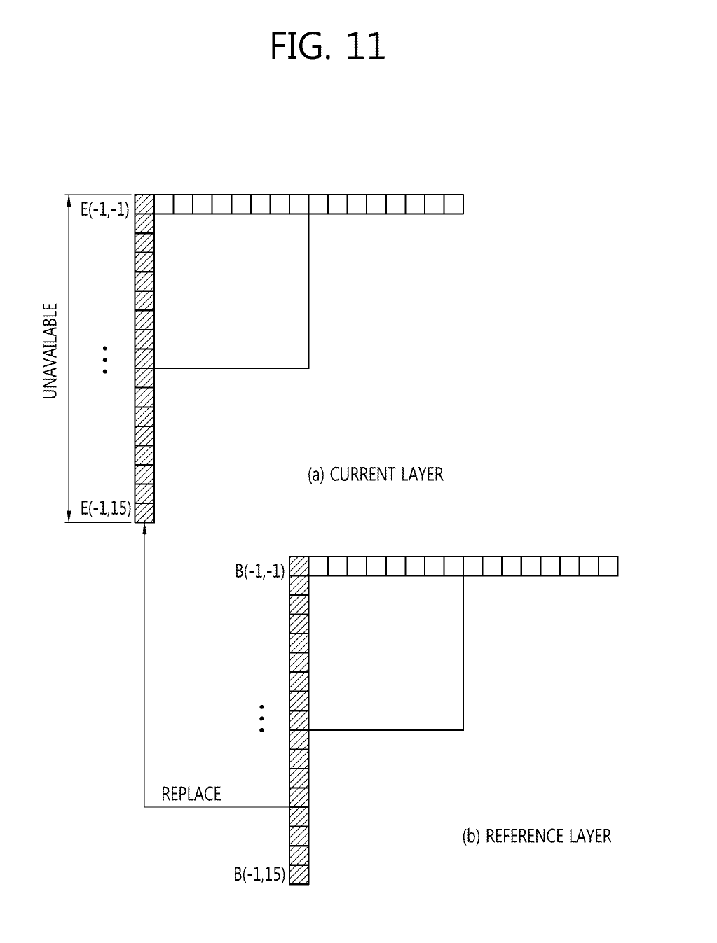

FIGS. 11 to 13 show the replacement of reference samples in a current layer based on a reference layer in accordance with another embodiment of the present invention.

Referring to FIG. 11, the reference samples adjacent to the left boundary of a prediction target block in a current layer (i.e., left/left-above/left-below reference samples) are unavailable due to a reason, such as that the prediction target block is located at the boundary of a picture, slice, or tile, etc. The block prediction module can replace the reference samples adjacent to the left boundary of a prediction target block in a current layer with the reference samples adjacent to the left boundary of a block corresponding to the prediction target block in a reference layer. That is, if reference samples located from (−1,−1) to (−1,15) in the current layer are unavailable, values of the corresponding reference samples can be replaced with values of reference samples located from (−1,−1) to (−1,15) in an up-sampled reference layer.

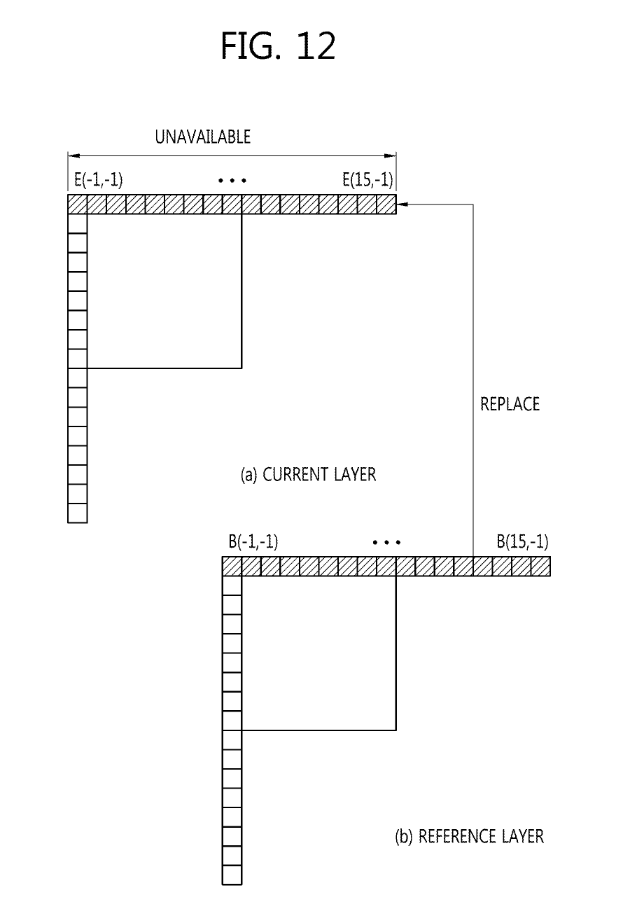

Referring to FIG. 12, the reference samples adjacent to the upper boundary of a prediction target block in a current layer (i.e., above/left-above/right-above reference samples) are unavailable due to a reason, such as that the prediction target block is located at the boundary of a picture, slice, or tile, etc. The block prediction module can replace the reference samples adjacent to the upper boundary of the prediction target block in the current layer with the reference samples adjacent to the upper boundary of a block corresponding to the prediction target block in a reference layer. That is, if reference samples located from (0,−1) to (15,−1) in the current layer are unavailable, values of the corresponding reference samples can be replaced with values of reference samples located from (0,−1) to (15,−1) in an up-sampled reference layer.

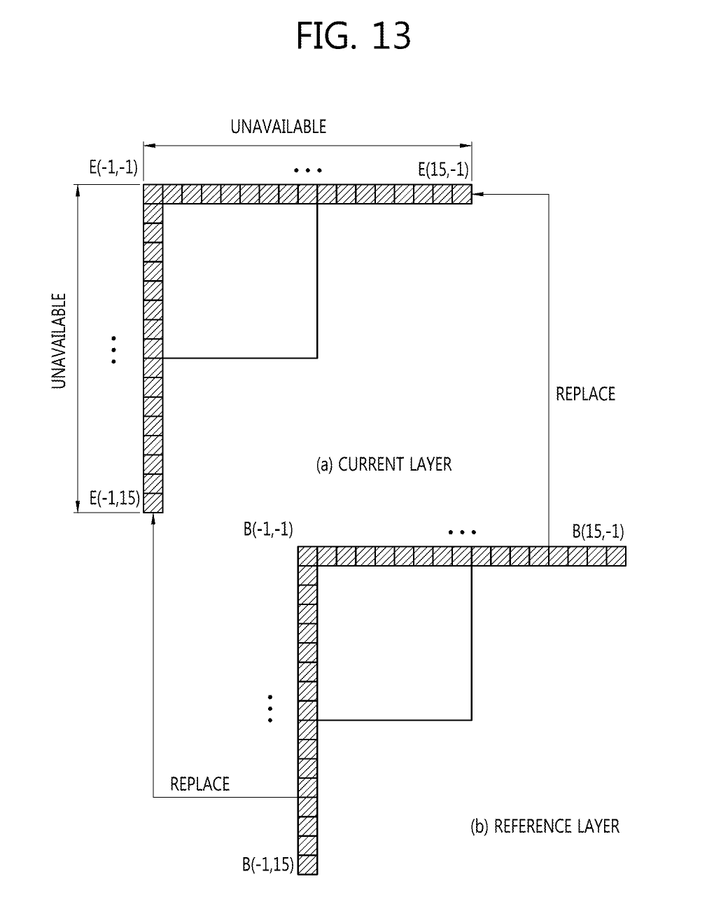

Referring to FIG. 13, all the reference samples of a prediction target block in a current layer are unavailable due to a reason, such as that the prediction target block is located at the boundary of a picture, slice, or tile, etc. The block prediction module can replace the reference samples of the prediction target block in the current layer with the reference samples of a block corresponding to the prediction target block in a reference layer. That is, if reference samples located from (−1,−1) to (−1,15) and reference samples located from (0,−1) to (15,−1) in the current layer are unavailable, values of the corresponding reference samples can be replaced with values of reference samples located from (−1,−1) to (−1,15) and values of reference samples located from (0,−1) to (15,−1) in an up-sampled reference layer.

Meanwhile, in the examples of FIGS. 11 to 13, all reference samples adjacent to the left boundary and/or reference samples adjacent to the upper boundary, of the prediction target block in the current layer, may be unavailable, but some of them may be unavailable. If some reference samples are unavailable, the unavailable reference samples are replaced with corresponding reference samples in a reference layer. For example, if a reference sample located at (−1,5) in the current layer is unavailable, a value of the corresponding reference sample can be replaced with a value of a reference sample located at (−1,5) in an up-sampled reference layer.

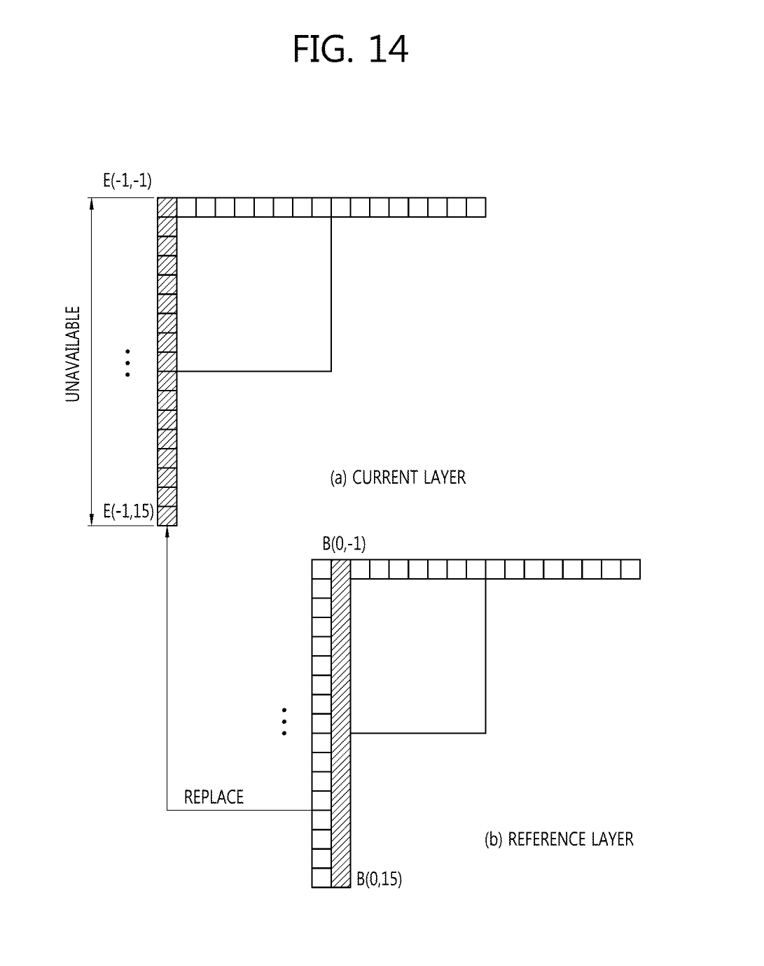

FIGS. 14 to 16 show the replacement of reference samples in a current layer based on a reference layer in accordance with yet another embodiment of the present invention.

Referring to FIG. 14, the reference samples adjacent to the left boundary of a prediction target block in a current layer (i.e., left/left-above/left-below reference samples) are unavailable due to a reason, such as that the prediction target block is placed at the boundary of a picture, slice, or tile, etc. In the case that prediction target block is located at the boundary of a picture, slice, or tile in the current layer, it is likely that a block corresponding to the prediction target block in the reference layer is also located at the boundary of a picture, slice or tile in the current layer. If the block corresponding to the prediction target block is located at the boundary of a picture, slice, or tile in the current layer, the neighboring reference samples corresponding to the prediction target block are also unavailable. Accordingly, the block prediction module can replace the reference samples adjacent to the left boundary of the prediction target block in the current layer with samples adjacent to samples corresponding to reference samples in a reference layer. That is, if reference samples located from (−1,−1) to (−1,15) in the current layer are unavailable, values of the corresponding reference samples can be replaced with values of reference samples located from (0,−1) to (0,15) in an up-sampled reference layer.

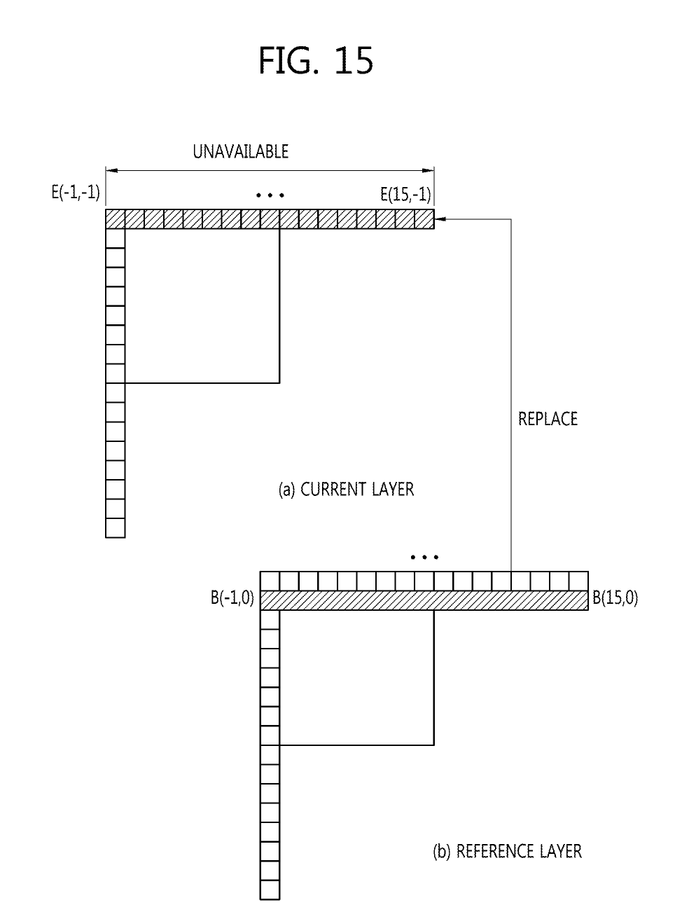

Referring to FIG. 15, the reference samples adjacent to the upper boundary of a prediction target block in a current layer (i.e., above/left-above/right-above reference samples) are unavailable due to a reason, such as that the prediction target block is placed at the boundary of a picture, slice, or tile, etc. Accordingly, the block prediction module can replace the reference samples adjacent to the upper boundary of the prediction target block in the current layer with samples adjacent to samples corresponding to reference samples in a reference layer. That is, if reference samples located from (−1,−1) to (15,−1) in the current layer are unavailable, values of the corresponding reference samples can be replaced with values of reference samples located from (−1,0) to (15,0) in an up-sampled reference layer.

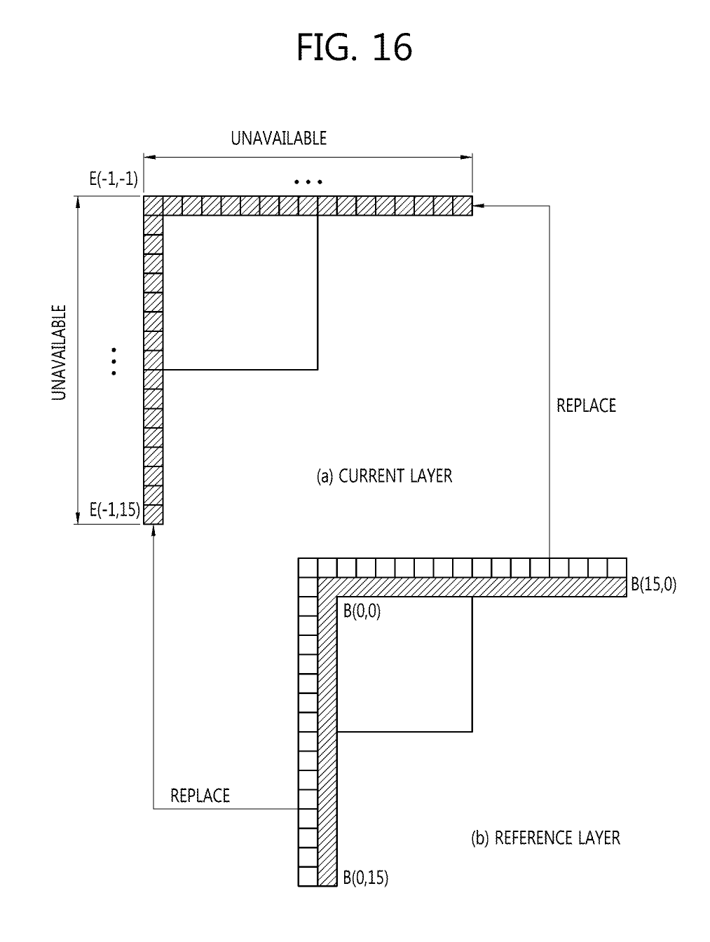

Referring to FIG. 16, all the reference samples of a prediction target block in a current layer are unavailable due to a reason, such as that the prediction target block is placed at the boundary of a picture, slice, or tile, etc. The block prediction module can replace the reference samples of the prediction target block in the current layer with samples adjacent to reference samples in a reference layer. That is, if reference samples located from (−1,−1) to (−1,15) and reference samples located from (0,−1) to (15,−1) in the current layer are unavailable, the reference sample located at (−1,−1) can be replaced with a sample located at (0,0), reference samples located from (−1,0) to (−1,15) can be replaced with samples located from (0,0) to (0,15), and the reference samples located from (0,−1) to (15,−1) can be replaced with reference samples located from (0,0) to (15,0).

Meanwhile, in the examples of FIGS. 14 to 16, all the reference samples adjacent to the left boundary and/or the reference samples adjacent to the upper boundary, of the prediction target block in the current layer, may be unavailable, but some of them may be unavailable. If some reference samples are unavailable, the unavailable reference samples are replaced with samples adjacent to reference samples in a reference layer. For example, if a reference sample located at (−1,5) in the current layer is unavailable, a value of the corresponding reference sample can be replaced with a value of a reference sample located at (0,5) in an up-sampled reference layer.

The process of replacing a reference sample (S720) may not be performed if all reference samples are available. Accordingly, a process of checking whether or not a reference sample is available may be performed before the process of replacing a reference sample (S720). For example, the block prediction module can check whether or not a prediction target block is adjacent to the boundary of a picture, slice or tile and determine whether or not a reference sample is available based on a result of the check.

Referring back to FIG. 7, the block prediction module generates a prediction block by performing intra prediction on the prediction target block (S730).

As described above, an HEVC-based video compression system supports non-angular modes, such as Intra_Planar mode and Intra_DC mode, and 33 angular modes as intra prediction. The block prediction module performs intra prediction based on a mode derived from among the 35 modes at step S710. Here, at step S720, a reference sample in a current layer replaced based on a value of a sample in a reference layer can be used.

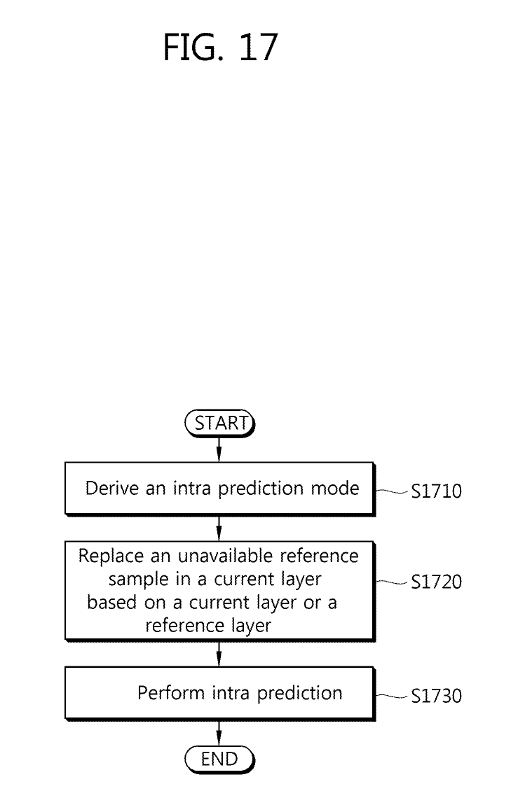

FIG. 17 is a flowchart illustrating an intra prediction method for a multi-layer video in accordance with another embodiment of the present invention.

Operations of the block prediction module in a step of deriving an intra prediction mode (S1710) and a step of performing intra prediction (S1730) are the same as those described with reference to FIG. 7.

In a step of replacing a reference samples (S1720), the block prediction module can selectively use a conventional method for replacing a reference sample and a method based on a sample value in a reference layer. That is, an unavailable reference sample can be replaced based on an available reference sample neighboring a prediction target block in a current layer; or an unavailable reference sample can be replaced based on a reconstructed sample in a reference layer. An indicator indicating that any one of the two methods has been used can be defined, and the indicator can be included in syntax and transmitted from the encoder to the decoder.

Meanwhile, although the aforementioned embodiments have been described based on the flowcharts represented in the form of a series of steps or blocks, the present invention is not limited to the sequence of the steps, and some of the steps may be performed in a different order from that of other steps or may be performed simultaneous to other steps. Furthermore, those skilled in the art will understand that the steps shown in the flowchart are not exclusive and the steps may include additional steps or that one or more steps in the flowchart may be deleted.

Furthermore, The above embodiments include various aspects of examples. Although all possible combinations for representing the various aspects may not be described, those skilled in the art will appreciate that other combinations are possible. Accordingly, the present invention should be construed as including all other replacements, modifications, and changes which fall within the scope of the claims.

1. An intra prediction method for a multi-layer video, comprising steps of:
deriving an intra prediction mode of a prediction target block of an enhancement layer;
generating a replacement sample corresponding to an unavailable reference sample of the prediction target block based on a reference layer corresponding to the enhancement layer; and
generating a prediction block corresponding to the prediction target block using the intra prediction mode and the replacement sample and available reference sample of prediction target block.

2. The method of claim 1, wherein the reference layer is obtained by up-sampling a base layer corresponding to the enhancement layer, based on a video size of the enhancement layer.

3. The method of claim 2, wherein the replacement sample may be a sample of reference layer corresponding to the unavailable reference sample in the enhancement layer.

4. The method of claim 2, wherein the replacement sample may be a sample adjacent to a sample of reference layer corresponding to the unavailable reference sample in the enhancement layer.

5. The method of claim 1, wherein the step of generating the replacement sample comprises a step of checking whether or not reference samples of the prediction target block are available.

6. The method of claim 5, wherein whether or not the reference samples are available is determined based on whether or not the prediction target block is adjacent to a boundary of a picture, slice, or tile.

7. An intra prediction method for a multi-layer video, comprising steps of:
deriving an intra prediction mode for a prediction target block of an enhancement layer;
generating a replacement sample corresponding to an unavailable reference sample of the prediction target block, the replacement sample generated based on an available reference sample of the prediction target block or a reference layer corresponding to the enhancement layer; and
generating a prediction block corresponding to the prediction target block using the intra prediction mode and the replacement sample and available reference sample of prediction target block.

8. The method of claim 7, wherein the reference layer is obtained by up-sampling a base layer corresponding to the enhancement layer, based on a video size of the enhancement layer.

9. The method of claim 8, wherein the replacement sample may be a sample of reference layer corresponding to the unavailable reference sample in the enhancement layer.

10. The method of claim 8, wherein the replacement sample may be a sample adjacent to a sample of reference layer corresponding to the unavailable reference sample in the enhancement layer.

11. A video decoder, comprising:
a block prediction module for generating a prediction block of the prediction target block; and
an adder for generating a reconstructed block by adding the prediction block to a residual block of the prediction target block received from a video encoder,
wherein the block prediction module is configuring for:
deriving an intra prediction mode of a prediction target block of an enhancement layer;
generating a replacement sample corresponding to an unavailable reference sample of the prediction target block based on a reference layer corresponding to the enhancement layer; and
generating a prediction block corresponding to the prediction target block using the intra prediction mode and the replacement sample and available reference sample of prediction target block.

12. The video decoder of claim 11, wherein the reference layer is obtained by up-sampling a base layer corresponding to the enhancement layer, based on a video size of the enhancement layer.

13. The video decoder of claim 12, wherein the replacement sample may be a sample of reference layer corresponding to the unavailable reference sample in the enhancement layer.

14. The video decoder of claim 12, wherein the replacement sample may be a sample adjacent to a sample of reference layer corresponding to the unavailable reference sample in the enhancement layer.

15. The video decoder of claim 11, wherein the block prediction module checks whether or not reference samples of the prediction target block are available.

16. The video decoder of claim 15, wherein whether or not the reference samples are available is determined based on whether or not the prediction target block is adjacent to a boundary of a picture, slice, or tile.
